(19) United States
(12) Patent Application Publication
(10) Pub. No.: US 2007/0268317 A1
(43) Pub. Date: Nov. 22, 2007

(54) User interface system and method for selectively displaying a portion of a display screen

(76) Inventor: Dan Banay, Seattle, WA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(21) Appl. No.: 11/437,853

(22) Filed: May 18, 2006

(51) Int. Cl. G09G 5/00

(52) U.S. Cl. 345/660

(57) ABSTRACT

A computer system or computing device includes a display for displaying the visual output of any number of software applications. A computer-implemented method of selectively displaying a magnified rendering of a portion of the display screen is executed on the computer system or computing device. The method allows the user to select a portion of the display screen for magnification and then displays a magnified rendering of that portion of the display screen. The magnified rendering retains the functional and interactive aspects of the underlying, non-magnified source content. The method also provides a configurable means of controlling the amount of magnification in the magnified rendering. The method permits using the magnified rendering to pan around within the underlying, non-magnified source content.

### TECHNICAL FIELD

This invention relates to computer software for displaying content on a computer or computing device display screen. In particular, the present invention relates to computer software for selectively displaying a magnified view of a portion of a display screen.

### BACKGROUND OF THE INVENTION

In recent years, computers, computing devices and associated peripherals have been undergoing a continual process of improvement. For example, virtually all computers and computing devices have become smaller and lighter due to advances in electronic miniaturization. The peripherals associated with such devices, including display screens, have likewise become smaller. These display screens, while becoming physically smaller, have also seen a dramatic increase in display resolution.

This increase in picture element (“pixel”) density can create a situation where it is difficult for people to see effectively what is being displayed on a display screen. For people with impaired vision, it may become impossible to use the computer or device associated with such a display screen. Even for people with normal visual acuity, such viewing difficulties can lead to a laborious and frustrating experience that seriously affects productivity and the enjoyment of the computer or computing device.

Prior art computer systems and their associated applications are sometimes equipped with the ability to magnify or zoom a portion of the display screen. Some versions of the Microsoft Windows® operating system, for example, include a program called “Magnifier.” Prior art methods such as Magnifier suffer from some drawbacks. For example, Magnifier permanently dedicates a portion of the screen to displaying the magnified view of whatever is under the pointer. This allocation of screen space reduces the amount of screen resolution available for displaying non-magnified content. Moreover, since the size of the magnifier display region is fixed, it may not magnify all of the relevant portions of the display at the same time. Magnifier also does not permit the user to directly interact with the magnified content. The magnified display region is not ‘live’ in that, for example, a magnified button is not functional. It can be clicked, but nothing will happen as a result of such click. Finally, the spatial relationship between the position of the magnified image and the image displayed on the screen is not maintained. For example, if the magnified viewing window is at the top of a display screen and a portion of the image at the bottom of the screen is selected for magnification, the selected portion at the bottom of the screen will appear in magnified form at the top of the screen. While prior art methods such as Magnifier provide the ability to change the amount of magnification, they do so only via a cumbersome, menu-based system. In order to change the magnification settings, the user must navigate through a menu and select some new, pre-set level of magnification that will take effect until the next such setting. Magnifier, and similar prior art methods, is little more than a simple, computer-implemented magnifying glass with a fixed amount of magnification.

Other prior art software applications often include some ability to zoom or magnify content displayed by such software. Adobe Reader 6.0, for example, allows the user to change the display magnification of the open PDF document. After selecting a zoom option from the Reader 6.0 menu, the pointer icon changes into the shape of a magnifying glass. The user points to the area of the document they wish to magnify and clicks a button. The PDF document rendering is then magnified and re-centered in the rendering region of the application window. Aside from increasing the magnification of the rendering, the size and position of the resulting magnified rendering is always the same. Moreover, such magnifier functionality within Reader 6.0 is restricted to use with only PDF document content. That is, aside from the rendering region of the application window, no other portion of the Reader 6.0 application window or content in any other window may be magnified with such functionality. This is a serious shortcoming because there is no ability for a user to magnify any of the Reader 6.0 toolbars or menus. Furthermore, by magnifying the entire PDF document, portions of the document for which magnification is not desired are also magnified, thus causing other portions of the documents to extend outside the display screen.

Another class of prior art software applications uses a magnification method that functions essentially like cropping. Microsoft® Streets and Trips (‘Streets’), for example, is a software application for viewing maps. Upon starting Streets, the application typically displays a map of the Western Hemisphere in the rendering region of the application window. The user may zoom in on sub-regions of this display by using the mouse or other pointer to draw a box around a selected sub-region and clicking a mouse button inside the selected sub-region. The selected sub-region is then enlarged to fit the rendering region of the application window while the region that lay outside the selected region is essentially cropped out of view. As with Adobe Reader 6.0, the size and position of the magnified rendering is fixed. Also as with Adobe Reader 6.0, Streets and its methods of magnifying a portion of the display screen do not function with any of the Streets toolbars, menus or indeed, any part of any other application.

There is therefore a need for an improved magnification method for intelligently magnifying portions of any and all portions of the display screen while maintaining the ability to interact with the magnified content. Such a method would preferably provide an intuitive and speedy means of changing the magnification as well. Ideally, the method would also automatically allow panning of the underlying content within the magnified rendering.

### SUMMARY OF THE INVENTION

The invention is directed to a system and computer-implemented method for selectively displaying a magnified portion of the display screen when used with computer systems and other computing devices. Typical computer systems and computing devices are generally equipped with a means of displaying information and graphics of various types. Certain computer operating systems and software applications provide only a limited means of displaying a magnified or zoomed version of some sub-portion of the display screen. Such operating systems and applications do not, for example, provide any ability for the user to directly interact with the magnified rendering. The computer-implemented method provides an enhanced means of selecting and displaying a magnified rendering of some portion of the display screen. Based on the location of a screen pointer, the method automatically determines the content and context of the display screen in an area under and around the screen pointer. Optionally, the method will magnify the current foreground window rather than the window under and around the screen pointer. The method uses the information about content to display a magnified version of such content. In so doing, the method provides that the magnified image retains the functional aspects of the underlying content and context. The method also provides a configurable means of interactively increasing or decreasing the magnification factor of the magnified rendering. The method also allows for the automatic panning of the underlying content within the magnified rendering. The provided method thereby greatly enhances the usability and accessibility of computer systems and their related applications.

### BRIEF DESCRIPTION OF THE DRAWINGS

FIG. 1 is a block diagram of a computer system in which an embodiment of the present invention is implemented.

FIG. 2 is a high-level flow diagram of one embodiment of the invention.

FIG. 3 is a flow diagram of the Prepare to Magnify Window subroutine of the high-level flow diagram shown in FIG. 2.

FIG. 4 is a flow diagram of one embodiment of a magnification routine.

FIG. 5a is a screenshot of a web browser application displaying a typical web page that contains a graphical image.

FIG. 5b is a screenshot of a web browser application displaying a typical web page and showing a magnified version of the graphical image shown in FIG. 5a.

FIG. 6a is a screenshot of a word processing application displaying a typical dialog box window.

FIG. 6b is a screenshot of a word processing application displaying a magnified version of the dialog box shown in FIG. 6a.

### DETAILED DESCRIPTION OF PREFERRED EMBODIMENTS

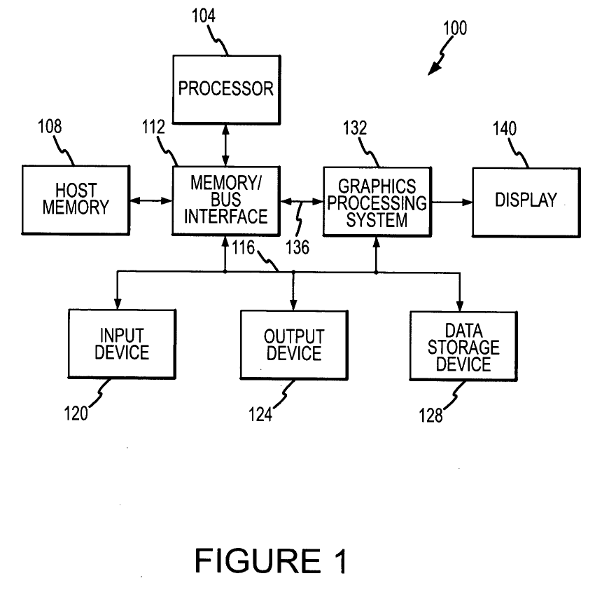

Embodiments of the invention provide a system and method for selectively displaying a portion of a display screen. Many specific details of certain embodiments of the invention are set forth in the following description and in FIGS. 1 through 6b in order to provide a thorough understanding of such embodiments. One skilled in the art, however, will understand that the invention may have additional embodiments, or that the invention may be practiced without several of the details described in the following description.

FIG. 1 illustrates an exemplary computer system 100 in which embodiments of the present invention may be implemented. Although described in terms of an embodiment implemented in an operating system or as a standalone application executing on a computer, those skilled in the art will recognize that the invention also may be implemented in combination with other program modules. Generally, program modules include routines, programs, components, DLL's, plug-in's, applets, data structures, and the like, that perform particular tasks or implement particular abstract data types. Those skilled in the art will further appreciate that the invention may be implemented with other computer system configurations, including hand-held devices such as, for example, cell phones, personal digital assistants (“PDA's”) or other microprocessor-based or programmable consumer electronics, multiprocessor systems, minicomputers, mainframe computers, and the like.

The computer system 100 includes a processor 104 coupled to a host memory 108 through a memory/bus interface 112. The memory/bus interface 112 is coupled to an expansion bus 116, such as an industry standard architecture (ISA) bus or a peripheral component interconnect (PCI) bus. The computer system 100 also includes one or more input devices 120, such as a keypad, a mouse or a handheld stylus, coupled to the processor 104 through the expansion bus 116 and the memory/bus interface 112. The input devices 120 allow an operator or an electronic device to input data to the computer system 100. One or more output devices 120 are coupled to the processor 104 to provide output data generated by the processor 104. The output devices 124 are coupled to the processor 104 through the expansion bus 116 and memory/bus interface 112. Examples of output devices 124 include printers and a sound card driving audio speakers. One or more data storage devices 128 are coupled to the processor 104 through the memory/bus interface 112 and the expansion bus 116 to store data in, or retrieve data from, storage media (not shown). Examples of storage devices 128 and storage media include fixed disk drives, floppy disk drives, tape cassettes and compact-disc read-only memory drives.

The computer system 100 further includes a graphics processing system 132 coupled to the processor 104 through the expansion bus 116 and memory/bus interface 112. Optionally, the graphics processing system 132 may be coupled to the processor 104 and the host memory 108 through other types of architectures. For example, the graphics processing system 132 may be coupled through the memory/bus interface 112 and a high speed bus 136, such as an accelerated graphics port (AGP), to provide the graphics processing system 132 with direct memory access (DMA) to the host memory 108. That is, the high-speed bus 136 and memory bus interface 112 allow the graphics processing system 132 to read and write host memory 108 without the intervention of the processor 104. Thus, data may be transferred to, and from, the host memory 108 at transfer rates much greater than over the expansion bus 116. A display 140 is coupled to the graphics processing system 132 to display graphics images. The display 140 may be any type of display, such as a cathode ray tube (CRT), a field emission display (FED), a liquid crystal display (LCD) and touchscreen variants of these, or the like, which are commonly used for desktop computers, portable computers, and workstation or server applications.

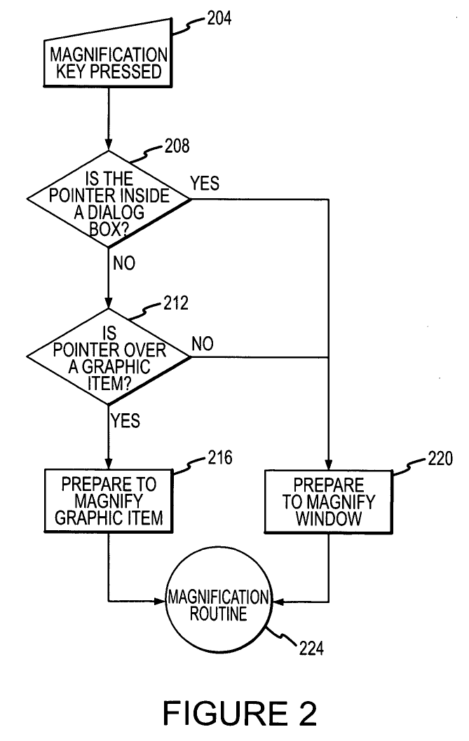

FIG. 2 illustrates a high-level flow diagram 200 of one embodiment of the invention, which can be used to program the processor 104 used in the computer system 100 of FIG. 1. Before magnifying a portion of the display, the user points to the portion of the display they wish to magnify. This is typically accomplished by using a mouse or other input device to put the mouse pointer above the area the user wishes to magnify. Magnification then commences at step 204 when the user presses a certain key combination or initiates some other action associated with magnifying the screen. As will be understood by one of skill in the art, another embodiment might reverse this sequence of events. For example, an embodiment of the invention implemented on a touchscreen enabled PDA such as a PalmPilot® would require that the user first initiate execution of the program and then using a hand held stylus, tap the screen at the appropriate location. In another embodiment of the invention, a setting is stored in the system registry, or other suitable location, and causes magnification to commence with the current foreground window rather than the display region under the mouse pointer.

Although described in terms of a key or keys being pressed, magnification might also commence when the user presses one of certain configurable buttons on a modem mouse. In the case of a touchscreen, magnification could likewise be initiated through a pre-defined set of screen taps or other input mechanisms. For the purposes of FIG. 2, however, it will be understood that the user points to the portion of the display they wish to magnify, and then presses a pre-determined magnification key or keys.

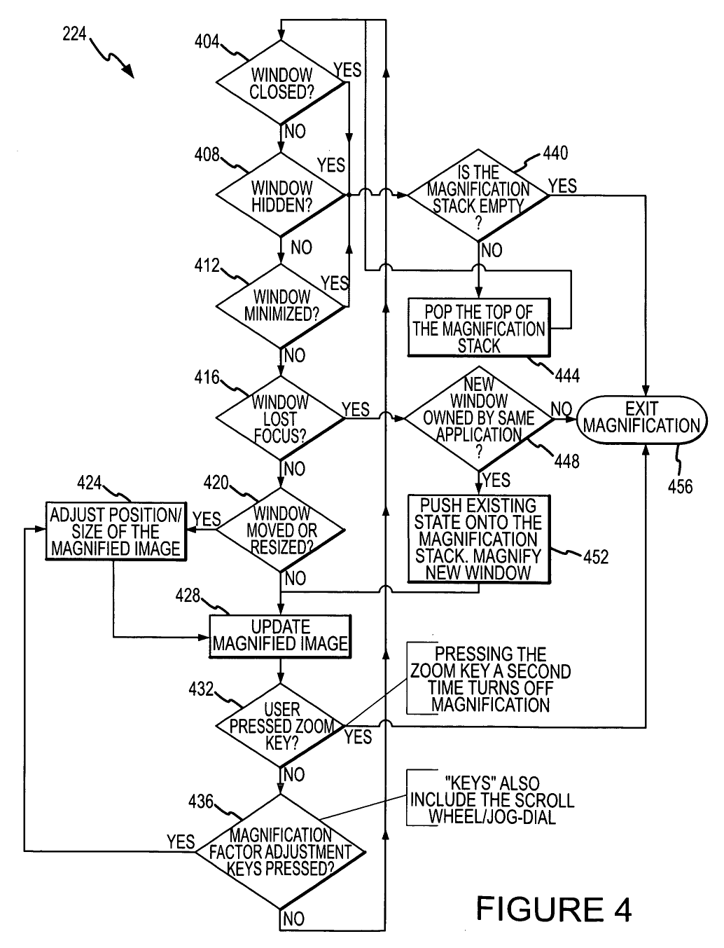

After the magnification key is pressed at 204, an embodiment of the invention then determines a display context. A display context is a rectangular portion of the display the user wishes to magnify and includes information about the graphical content of the region beneath the pointer as well as the location of the pointer within the display region. However, a portion of the display having a different shape, such as a circle, may also be used for the display context. The region beneath the pointer could contain, for example, purely graphical content such as graphic images, or it might contain a dialog box or other window that the user needs for interacting with an application. The determination of the display context will be explained in greater detail in the description of FIG. 4 below.

The display context is determined by first testing whether the pointer is over a dialog box at 208. A dialog box is a special type of window that is not allowed to be resized by the user. In some cases, it is important to disallow such resizing because controls or important information within the dialog box might become hidden if the dialog box is resized inappropriately. When the pointer is over a dialog box, the display context is determined to be the dialog box beneath the pointer and its location. Program flow then continues onto 220 to prepare to magnify the dialog box window. If the pointer is not over a dialog box, one further check is made at 212 to determine if the pointer is over a graphic item. This ordering of tests at 208 and 212 ensures that the magnification routine never magnifies a graphic item within a dialog box. A graphic item may be any type of graphical image, such as JPEG, GIF, TIFF, BMP, PCX, PCD, PICT, PNG, TGA, ICO, or the like, which are commonly used digital image types and as may be displayed by computers or computing devices. A graphic item can also be a dynamic item, such as a chart in a spreadsheet. The zoom utility uses the Microsoft Accessibility APIs to determine the role an item plays in the user interface. If the pointer is determined at 212 to be over a graphic item, the display context is determined to be the graphic item itself and its location as selected by the pointer, and program execution continues to 216. If it is determined at 212 to not be over a graphic item, then the display context is determined to be the application window beneath the pointer, and its location as selected by the pointer. In that event, program execution continues to 220.

Preparations to magnify either a graphic item at 216 or a dialog box at 220 involve many of the same tasks. In both cases, the pixels of the relevant sub-rectangle of the screen are determined and copied. At 216, this rectangular portion of the screen is determined according to the properties of the graphic item and generally corresponds to the bounding box of that item. In the case of a dialog box, preparations at 220 set the sub-rectangle to be the bounding area of the window itself. Once the sub-rectangle to be magnified is determined, a hardware video overlay is created in order to display the magnified image. As will be understood by one of skill in the art, the use of a hardware video overlay is preferable because it utilizes features of the graphic processing system 132, as shown in FIG. 1, to compute and maintain the image thus offloading the CPU. Additionally, since a hardware video overlay operates independently of the windowing/operating system, there are no magnification related side-effects to impair the performance of the software application associated with the window being magnified. Systems with less sophisticated graphic processing systems that are incapable of supporting hardware video overlays may nevertheless be used to implement an embodiment of the invention albeit with lower performance.

A magnified graphic item is just an enlarged version of the base graphic item and such an item is displayed for its visual content only. There is no need to manipulate or interact with the graphic item beyond simply magnifying the item for improved viewing. In the event the display context is a dialog box or other window, then an embodiment of the invention would magnify the entire dialog box or window while at the same time permitting manipulation and interaction with the magnified dialog box or window. Preparations to magnify a window at 220 further include such operations as are required to magnify that window while keeping the magnified rendering of that window “live.” Preparing to magnify either a window or graphic item also requires an initial determination of the size and position that the magnified image should have. The position of the magnified image is determined by a number of factors. Most typically, the location of the magnified image is centered over the rectangular portion of the display being magnified. Sometimes however, such a position would not be possible. For example, where a graphic item is located very close to the edge of the display screen, displaying the magnified image centered in that position would place a portion of the magnified image off one or more edges of the screen. In that event, the magnified image is determined to have a location as close as possible to the pointer location to avoid any such loss of the image due to edge effects. The determination of the position of a dialog box or window is done in a similar fashion.

The size of the magnified image is also determined when preparing to magnify either a graphic item or a window. In the case of a graphic item, the size of the magnified version of that item is typically magnified by some relatively small factor to maintain some viewability of the background. For example, magnifying a very small graphic item such that it takes up the whole screen would not allow viewing of the graphic item in its context and could grossly distort the overall rendering of the image. It is generally preferable to render the graphic item with a relatively small magnification factor initially. Although this embodiment is described in terms of the initial magnification factor being determined programmatically, another embodiment might allow the user to configure the default magnification factor. Where the display context is instead a window, the routine generally will attempt to maximize the area of the magnified rendering of the window. Whether the display context is a graphic item or a window, the magnification factor of the image may be changed at any time by the user as will be discussed more fully below. When the display context is a dialog box or other window, it is important to understand that the magnified display of such a dialog box remains completely functional in its magnified state. That is, although the dialog box is now being displayed in a magnified form, all buttons, menus, options, text fields, and the like, remain fully functional. The user may directly interact with the magnified dialog box as if it had not been magnified.

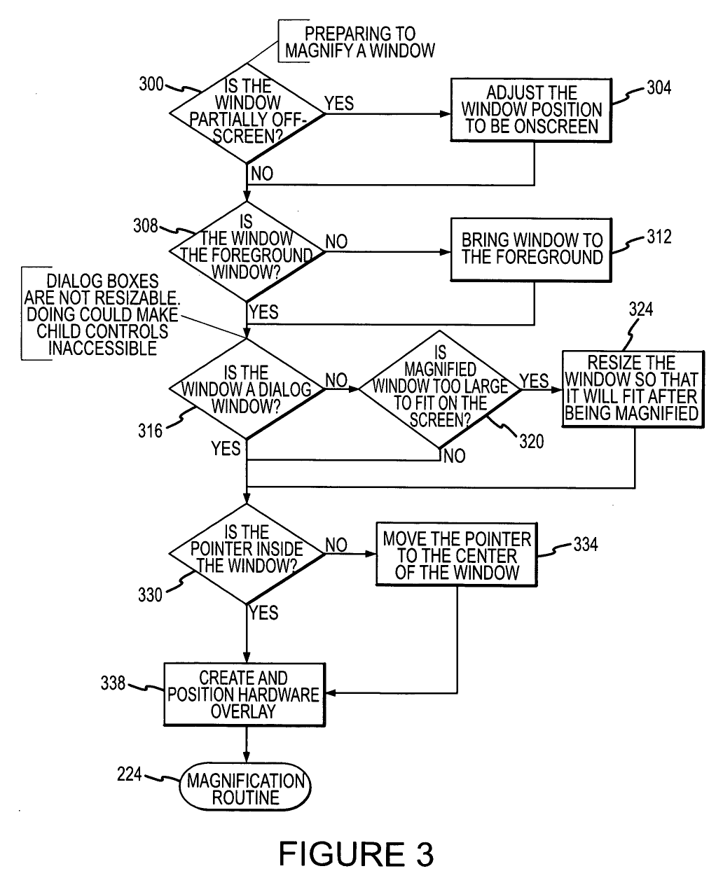

FIG. 3 illustrates in greater detail the preparations to magnify window routine 220. The preparations begin at 300 with a test of whether the chosen or active window is completely on the screen. Where this is not true, the window is re-positioned at 304 so as to be onscreen. After ensuring the window is completely on screen, execution continues at 308 with a test of whether the chosen window is the foreground window. Again, if the window is not in the foreground, the routine brings the window to the foreground at 312 and flow continues to 316. The routine determines whether the chosen window is a dialog box at 316. In the event the routine determines the window is not a dialog box at 316, the routine computes an initial size for the magnified image and then determines if that image would be too wide to fit on the display screen at 320. If the image would be too large, the initial size of the magnified image is recomputed so as to fit on the display after being magnified at 324 and program flow continues to 330. If the computed size for the initial image is acceptable, execution likewise continues to 330. Dialog boxes are excepted from this resizing behavior because they are generally large relative to the size of the display screen and re-sizing such dialog boxes so as to fit on the display screen might provide little or no initial magnification.

Preparations to magnify continue with a determination of whether the pointer is currently inside the window that will be magnified at 330. Where this is not true, the pointer is moved to the center of the window at 334. Lastly, after these preparations are complete, the hardware overlay is created and positioned and the initial magnified image is thereby displayed with the precomputed position and magnification factor. Program control then passes to the magnification routine 224 for management of the magnified image.

Although not shown, preparations to magnify a graphic item are virtually identical to preparing to magnify a window 220. In the case of a graphic item, however, there is no need to determine whether the window is a dialog box at 316. Likewise, the logic associated with the routines of 320 and 324 is not necessary.

FIG. 4 illustrates in greater detail the magnification routine 224. In one embodiment of the invention, the magnification routine 224 comprises a loop. This loop is entered at 404 with a test of whether the window has been closed. The first time this loop is entered, each of the tests at 404 through 420 will typically, though not necessarily, be false and program flow will fall through to 428. On successive iterations through the loop, the tests at 404 through 420 may result in different behavior as is described more fully below. On this initial traversal of the loop, there are no updates to perform on the magnified image and program flow continues to 432.

The magnification loop continues at 432 with a test of whether the user has pressed the magnification key a second time. In such an event, display of the magnified image ceases at 456. If the magnification key has not been pressed, the routine continues by testing for changes in the desired magnification factor at 436.

As was mentioned above, during display of the magnified image, the user may increase or decrease the magnification factor of the magnified image. Typically, two hot-keys are configured to control the increase or decrease of the magnification factor. For example, a hot-key might be configured where holding down the Ctrl key on the keyboard and pressing the Up Arrow key would increase the magnification factor and likewise, holding down Ctrl and pressing the Down Arrow would decrease the magnification factor. As will be understood by one of skill in the art, other means for signaling these magnification factors are possible. For example a mouse wheel, scroll wheel, jog-wheel, jog-dial, or the like, could be used to change the magnification factor while the magnified image is being displayed. This embodiment of the invention detects a user-initiated change to the magnification factor at 436. When such a change is detected, information about the amount of change (e.g. how many clicks of the scroll wheel and/or number of key presses) is passed back to 424 for re-determining the size and position of the magnified image and flow then continues as before. After the size and position have been re-determined at 424, program flow continues onto 428 for an update of the magnified image. The magnified image is re-displayed at 428 using the new size and position and according to the change in the magnification factor. In some instances other updates to the magnified image may be required and these are accomplished at 428 as well.

One embodiment of the invention provides automatic panning through the content underlying the magnified image. As was discussed in the description of FIG. 3, at the end of preparing to magnify a window, but just prior to displaying the magnified image, the pointer is moved to the center of the window. Thus, upon the initial display of the magnified content, the pointer will be visible within the magnified rendering. If the user attempts to move the mouse pointer outside the bounds of the magnified image, the magnification routine 224 will automatically update the magnified image at 428. This update is accomplished by selecting a new sub-rectangle to be magnified from the underlying window. This new rectangle is the same size as the existing sub-rectangle, but shifted in the direction that the mouse was moved. For example, suppose the user has moved the pointer to the top-most border of the magnified image. The magnification routine at 428 will detect the pointer's proximity to the border and move the selected sub-rectangle of the underlying content up. This behavior is likewise true for each of the four borders of the magnified image and the magnification routine will allow panning throughout the underlying content up to the bounds of that content. Once this new sub-rectangle has been determined, its pixels are copied as before and the hardware overlay is updated thus re-displaying the panned image.

After the magnified image updates at 428, due either to changes in the magnification factor or because of panning, flow typically continues through 432 and 436 and back to step 404 where a series the tests 404 through 420 are performed to determine if the display has changed state. Such a change may have occurred in any of several ways. Since the last check of the display state, the window associated with the magnified image may have been closed, hidden, minimized, have lost focus, or been moved and/or resized. As was discussed briefly above, during the first traversal of the loop, none of these events will typically have occurred. For the forthcoming discussion of the tests shown at 404, 408, 412, 416 and 420, it will be understood that although discussed in terms of testing for a change in the state of a window, the tests are performed both when the display context is a graphic item as well as when it is a dialog box or other window. Where the display context is a graphic item, the tests are performed on the window where the graphic item is located. When the display context is a dialog box or other window, the tests are performed on the dialog box or window itself.

The first test is performed at 404 to determine whether the window has been closed. In the event the window has closed, control passes to 440 as will be discussed more fully below. If the window has not been closed, program execution continues at 408 with a test of whether the window has become hidden. The window might become hidden for any number of reasons. Most typically, a new window has opened on top of the magnified window thereby obscuring the magnified window from view. If the window is hidden, control passes to 440, otherwise control passes down to 412. Program flow continues at 412 where a test is performed to determine whether the window has been minimized. In almost all cases, a window becomes minimized because the user has manually done so. If the window has become minimized, the magnification routine continues at 440. Otherwise, flow continues on to 416 to test whether the window has lost focus. A window loses focus when a new window has opened and user input in being directed to that window. This could happen for a number of reasons. For example, a user may select one or more menu options in a software application that causes a dialog box to be displayed. When the window has not lost focus, the last remaining test of whether the window has been moved or resized is performed at 420.

If it is determined at 416 that the window has lost focus, flow branches to 448 where a test performed is performed to determine whether a new window is owned by the same application. This test can best be understood by way of an example. Suppose the user is running a software application and has magnified a dialog box of the application. As noted above, the dialog box is fully functional in its magnified form and the user may interact with the dialog box as if it had not been magnified. Further, suppose that the user initiates some action in the dialog box which causes a new dialog box or window to open. When the new dialog box opens such that the previous dialog box is still visible, this new window now has focus while the old window has lost focus. Since the old window was not closed, hidden or minimized, the magnification loop will detect that the window lost focus at 416 and pass control to the test at 448. The test at 448 determines whether the window currently in focus is owned by or is running in the same application as that of the window that was in focus. In our example thus far, the new dialog box is, in fact, running as part of the same application. Because of this, the previous magnification state of the display is saved at 452 and the new window now in focus is magnified instead. When saving the previous magnification state of the display, magnification information about the dialog box that was previously in focus is stored. This information typically contains information about the location of the magnified image and its size and/or magnification factor. As will be understood by one of skill in the art, the most natural abstract data type for storing and retrieving such information is a stack. Although this embodiment is described in terms of a stack, it will be understood that other embodiments of the invention may use other abstract data types. The saved magnification state is used later at 440 and 444 as is discussed more fully below. After saving the previous magnification state of the display, the newly opened dialog box is magnified by determining its position and size at 452 and then updating the displayed image at 428. Program flow then continues at 432 as has been described above. In the event the new window is not owned by the same application as the previous window, the magnification routine exits at 456 and the magnified image is removed from the display.

The saved magnification state will be used later when the user has finished interacting with the currently magnified window and, for example, closes that window. Assuming such a magnification state has been saved, if the current window associated with the currently displayed magnified image is closed, hidden or minimized, the magnification routine will detect such at 404, 408 or 412 respectively, and pass control to 440. At 440, the magnification routine determines if there is a saved magnification state on the stack. Where such a state exists, it is popped off the stack and the magnified image associated with the state is re-displayed with the saved size and position at 444. At that point, program control returns back to the main loop of the magnification routine at 404. If it is determined at 440 that no magnification state is stored on the stack, then the magnification routine exits at 456 and the magnified image is removed from the display.

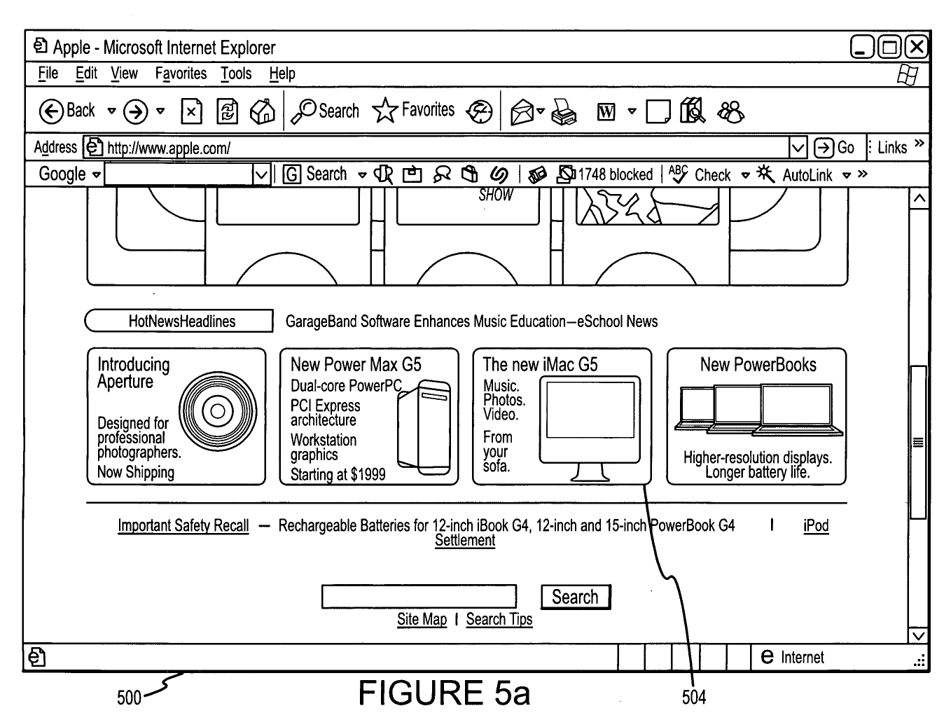

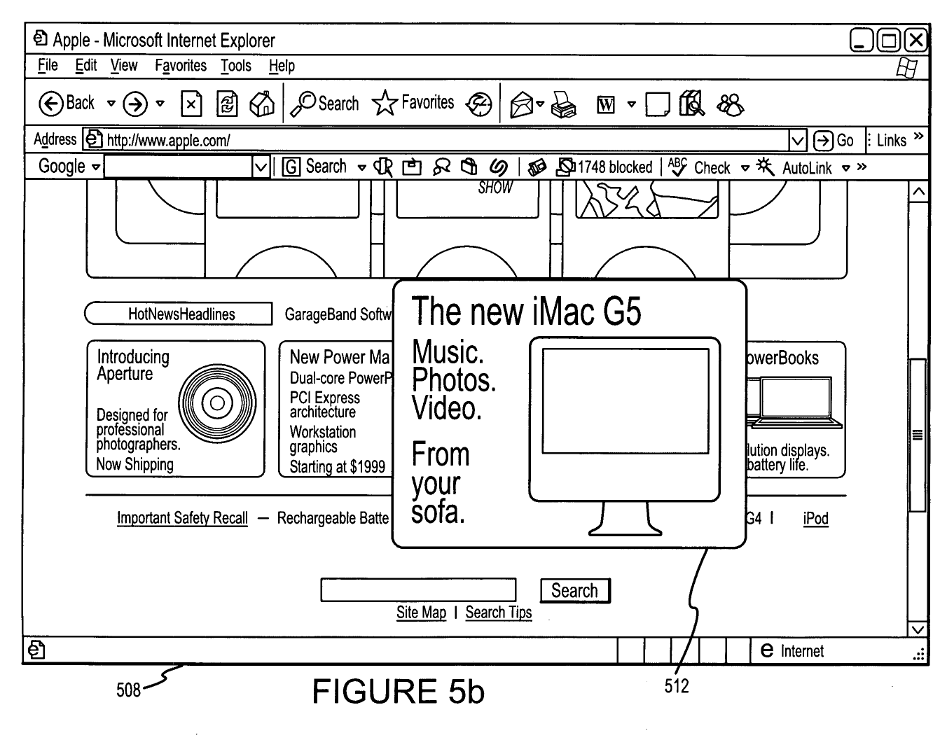

FIG. 5a illustrates a screenshot 500 of a web browser application displaying a typical web page that contains a graphical image 504. As discussed above in greater detail, the graphical image 504 may be of virtually any type of graphical image.

FIG. 5b illustrates a screenshot 508 of a web browser application displaying a typical web page and showing a magnified version 512 of the graphical image 504 shown in FIG. 5a. As outlined above, the graphic item is magnified with a relatively small initial magnification factor. This allows the graphic item to be viewed in the context of the entire webpage more easily.

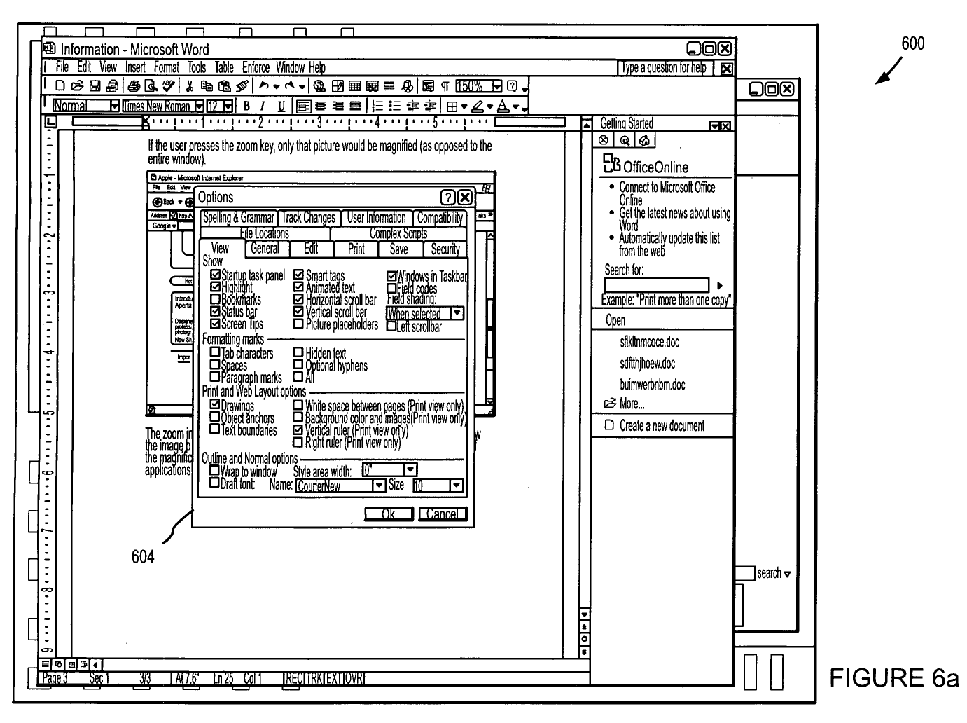

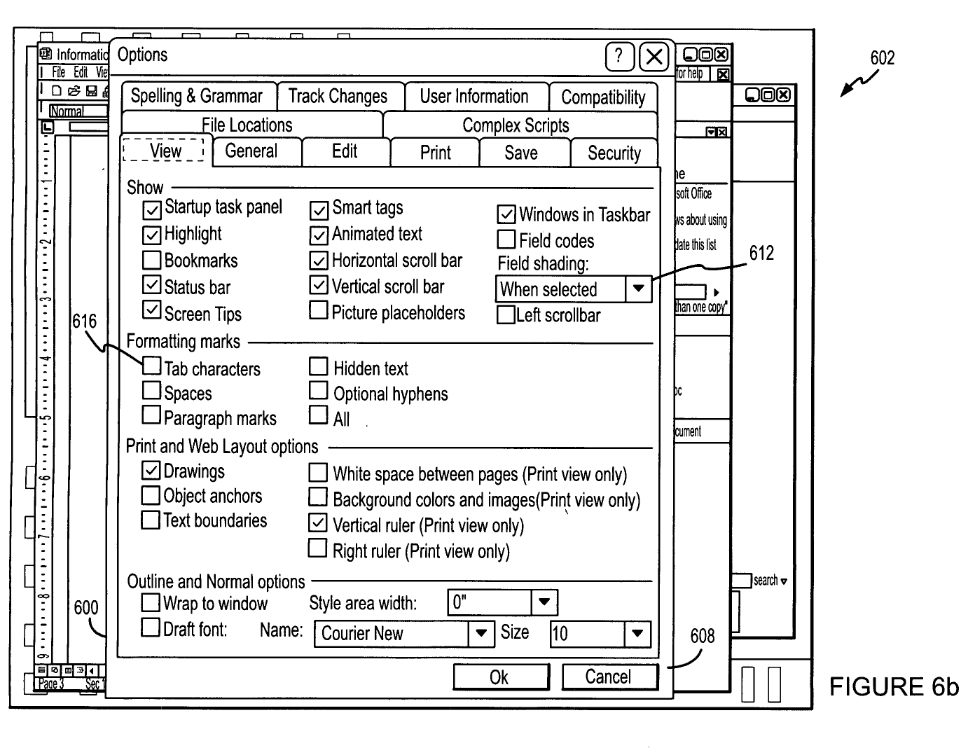

FIG. 6a is a screenshot 600 of a word processing application displaying a typical dialog box window 604.

FIG. 6b is a screenshot 602 of a word processing application displaying a magnified version 608 of the dialog box 604. As noted above, the magnified image is fully “live” and the user may directly interact with the magnified dialog box. For example, the Field shading dropdown box 612 may be selected and its options changed. Likewise, the Tab characters checkbox 616 may be set or cleared. Also as discussed above, the dialog box has been magnified with a relatively large factor so that the dialog box uses nearly the entire display area. This initial magnification factor is generally preferable since dialog boxes are usually complex and may contain a large number of input options. In such situations, viewability and usability of the magnified dialog box is of paramount importance. Also, the operating context of the dialog box is generally less important than that of a graphic item.

Although the invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

What is claimed is:

1. A computer implemented method for selectively magnifying a portion of a display screen in response to a magnification signal, the method comprising:
determining a display context;
determining a position on the display screen for a magnified image of the display context wherein the position is related to a selected location on the display screen;
determining a size and a magnification factor for the magnified image; and
displaying the magnified image with the determined position, the determined size and the determined magnification factor wherein the magnified image has the functional properties of the display context.

2. The method of claim 1 further comprising:
while displaying the magnified image, detecting a first signal;
in response to detecting the first signal, increasing the magnification factor for the magnified image and re-displaying the magnified image with the determined size, the determined position and the increased magnification factor.

3. The method of claim 2 further comprising:
while displaying the magnified image, detecting a second signal;
in response to detecting the second signal, decreasing the magnification factor for the magnified image and re-displaying the magnified image with the determined size, the determined position and the decreased magnification factor.

4. The method of claim 3 further comprising:
while displaying the magnified image, detecting a third signal;
in response to detecting the third signal, terminating display of the magnified image.

5. The method of claim 4 further comprising:
while displaying the magnified image, detecting a change in state of the display to provide a new display state;
in response to detecting a change in the state of the display, re-determining the size, position and magnification factor for the magnified image in accordance with the new display state and re-displaying the magnified image.

6. The method of claim 1 wherein the act of determining a display context comprises:
using a pointing device to place a cursor over a portion of the display screen showing the determined display context.

7. The method of claim 1 wherein the act of determining a position on the display screen for a magnified image of the display context comprises:
determining a location of the display context on the display screen; and
using the position of the display context as the selected location on the display screen.

8. A system configured to selectively magnify a portion of a display screen in response to a magnification signal, the system comprising:
a processing component;
a display screen coupled to the processing component;
a data storage component coupled to the processing component and storing a magnification program executed by the processing component and configured to:
determine a display context;
determine a position on the display screen for a magnified image of the display context wherein the position is related to a pointer location on the display screen;
determine a size and a magnification factor for the magnified image;
display the magnified image with the determined position, the determined size and the determined magnification factor wherein the magnified image has the functional properties of the display context.

9. The system of claim 8 wherein the magnification program executed by the processing component is further configured to:
while displaying the magnified image, detect a first signal;
in response to detecting the first signal, increase the magnification factor for the magnified image and re-display the magnified image with the determined size, the determined position and the increased magnification factor.

10. The system of claim 9 wherein the magnification program executed by the processing component is further configured to:
while displaying the magnified image, detect a second signal;
in response to detecting the second signal, decrease the magnification factor for the magnified image and re-display the magnified image with the determined size, the determined position and the decreased magnification factor.

11. The system of claim 10 wherein the magnification program executed by the processing component is further configured to:
while displaying the magnified image, detect a third signal;
in response to detecting the third signal, terminate display of the magnified image.

12. The system of claim 11 wherein the magnification program executed by the processing component is further configured to:
while displaying the magnified image, detect a change in state of the display to provide a new display state;
in response to detecting a change in the state of the display, re-determine the size, position and magnification factor of the magnified image in accordance with the new display state and re-displaying the magnified image.

13. The system of claim 8, further comprising a pointing device, and wherein the magnification program executed by the processing component is configured to determine the display context by using the pointing device to place a cursor over a portion of the display screen showing the determined display context.

14. The system of claim 8 wherein the magnification program executed by the processing component is configured to determine a position on the display screen for a magnified image of the display by:
determining a location of the display context on the display screen; and
using the position of the display context as the selected location on the display screen.

15. A computer-readable medium whose contents cause a computer system to selectively magnify a portion of a display screen in response to a magnification signal by performing the steps of:
determining a display context;
determining a position on the display screen for a magnified image;
determining a size and a magnification factor for the magnified image;
displaying the magnified image with the determined position, the determined size and the determined magnification factor wherein the magnified image has the functional properties of the display context.

16. The computer-readable medium of claim 15 wherein the contents of the computer-readable medium further causes a computer system to:
while displaying the magnified image, detect a first signal; and
in response to detecting the first signal, increase the magnification factor for the magnified image and re-display the magnified image with the determined size, the determined position and the increased magnification factor.

17. The computer-readable medium of claim 16 wherein the contents of the computer-readable medium further causes a computer system to:
while displaying the magnified image, detect a second signal; and
in response to detecting the second signal, decrease the magnification factor for the magnified image and re-display the magnified image with the determined size, the determined position and the decreased magnification factor.

18. The computer-readable medium of claim 17 wherein the contents of the computer-readable medium further causes a computer system to:
while displaying the magnified image, detect a third signal; and
in response to detecting the third signal, terminate display of the magnified image.

19. The computer-readable medium of claim 18 wherein the contents of the computer-readable medium further causes a computer system to:
while displaying the magnified image, detect a change in state of the display to provide a new display state; and
in response to detecting a change in the state of the display, re-determine the size, position and magnification factor for the magnified image in accordance with the new display state and re-display the magnified image.

20. The computer-readable medium of claim 15 wherein the contents of the computer-readable medium further causes a computer system to use a pointing device to place a cursor over a portion of the display screen showing the determined display context.

21. The computer-readable medium of claim 15 wherein the contents of the computer-readable medium further causes a computer system to determine a position on the display screen for a magnified image of the display context by:
determining a location of the display context on the display screen; and
using the position of the display context as the selected location on the display screen.
